(19) United States
(12) Patent Application Publication
(10) Pub. No.: US 2007/0245946 A1
(43) Pub. Date: Oct. 25, 2007

(54) Mine escape system

(75) Inventor: Allen Garrett Smith, Johnstown, PA (US)

Correspondence Address: Lawrence R. Burns, Esquire, 310 Coulter Bldg., 231 S. Main St., Greensburg, PA, 15601, US

(73) Assignee: Cambnia County Association, Johnstown, PA (US)

(21) Appl. No.: 11/408,250

(22) Filed: Apr. 20, 2006

(51) Int. Cl. G01D 13/22

(52) U.S. Cl. 116/205

(57) ABSTRACT

The improved mine escape line having a length of braided metallic cable preferably galvanized steel, with opposing ends with quick connectors located on each end. Located along the line at spaced intervals are tactile feedback information markers are fastened around the line for indicating by touch the direction of travel for safety or exits purposes. The braided metallic line has an outer protective layer of transparent plastic.

### BACKGROUND OF THE INVENTION

1. Field of the Invention

This invention relates to safety equipment for use in a mine and more particularly to improvements to mine escape line used for directional information in underground mining operations.

2. Description of the Prior Art

A seam of coal is normally found as a layer of material approximately two to twelve feet in thickness that extends as a seam underneath the surface of the earth. To mine the seam of coal entrance ways are formed in an open face of the seam and shafts are formed extending into the seam formation by removing the coal or other mineral. In coal mining there are usually three shafts that start at the face and continue almost parallel to one another. Fresh air must be continually supplied to the miners working in the mine and to achieve that goal air is continuously pumped into the mine through one or two of the extending parallel shafts. The third shaft is the return airshaft and that shaft not only serves as the return airshaft but also is the escape route for the miners that may have to exit the mine under any conditions. As the original entrances or shafts extend deeper into the seam and therefore deeper into the earth, it is necessary to provide cross-shafts that are formed perpendicularly to and interconnect with the original shafts. When such original shafts and interconnecting shafts are formed they constitute a confusing maze to a miner even under the best of conditions. A person that is underground lacks a sense of direction. With the confusing maze of tunnels and cross shafts in the mine it is not obvious which direction one has to travel to reach safety or to exit the mine. In an emergency or under very adverse conditions a miner will need a form of tactile or other type of direction indicators to exit the mine.

U.S. Pat. No. 4,179,160 granted Dec. 18, 1979 describes the mine conditions more fully and the need for an escape system tactile directional line.

In the early 1980s Cambria County Association for Blind and Handicapped was contacted to develop an escape for the Kerr McGee Galatia Mine in the State of Illinois. CAB was contacted by the mine to develop a product so that in case of fire or explosion resulting in smoke that would impede vision and orientation in the mine. One of the main problems in a mine fire is that miners can't see and get disoriented and many times go in the opposite direction, in other words go further into mine instead of out. This information was specifically obtained through eyewitness accounts at the Orangeville Utah fire and the Marianna Pa. fire. Cambria County in association with others developed the now standard type lifeline and was coordinated through the National Mine Service Company located in Mt. Vernon Ill. The escape line that was developed was a braided polypropylene rope with tactile directional indicators to indicate the proper direction to escape from the mine. Various cone sizes were tried to develop the proper size and shape that would work best in this application. The final design was a cone that was large enough to clearly indicate proper direction for escape from the mine, yet small enough to not break a handgrip when in actual use. These directional cones were installed on one-quarter inch polypropylene rope. After the final design of the cone it was desired that the cones should be spaced at 75-foot intervals on a three hundred foot spool of lifeline. To improve safety, it was decided to add green reflective tape on the cone surface. Four half inch wide green reflective bands were applied to the cone surface. If the miner were traveling in the proper direction those reflective bands would be oriented laterally along the cone surface. If a miner were traveling in the wrong direction the reflective tape would be in an X pattern to indicate wrong direction turn around. The shape of the cone will help indicate the direction of travel to escape from the mine. If a miner's hand slides over the pointed end smoothly he will know he is going in the proper direction to exit the mine. If the miner's he hand hits the blunt end of the cone, it indicates that it is the wrong direction for escape from the mine. During development of the life line it was also determined that a solid strong cone would be better than a hollow type device which could be broken or easily removed in the mine. By having a solid cone with the rope running through the cone it would be very tamper resistant and difficult to remove or break. This solid directional cone was permanently affixed to the lifeline with aluminum stop sleeves. On both ends of the lifeline galvanized thimbles and aluminum sleeves were used so that multiple sections of the lifeline could be attached in one strong unit. Individual sections were connected with quick links. The original part number for a 300-foot spool lifeline with direction indicators every 75 feet was CAB Part #0645. This lifeline was sold consistently year in and year out at this location through the 1990s to the National Mine Service Company and other distributors. The concept gradually spread to other mines in the US. At the time of its development no one at CAB or the National Mine Service Company or other distributors were aware of similar type of escape line. Because there was not a commercially available product and Cambria County Association For The Blind and Handicapped manufactured high quality mine safety products, CAB was approached for this new product development. The National Mine Service and Kerr McGee have used the original product for many years.

After its introduction several states started requiring such escape lines in their mines but each state seemed to have a different requirement for the spaced apart placement of the cones. In an attempt to allow each mine to purchase a standard line and then modify it to meet their states requirements U.S. Pat. No. 5,988,101 was granted on Nov. 23, 1999.

Although the use of the polypropylene rope material has had a lengthy service, there were certain problems associated with the use of such a material. One of the problems was that as the polypropylene rope material extended along the length of the mine shafts the rope had occasion to rub against the various rock, mineral and other formations.

This rubbing action at times had a deleterious effect on the integrity of the rope. Fire and explosions along the path of the rope also had a tendency to destroy the continuity of the rope.

### BRIEF SUMMARY OF THE INVENTION

According to the present invention a mine escape line is provided which comprises a length of braided metallic cable with opposing ends with quick connectors located on each end. Located along the line at spaced intervals are tactile feedback information markers fastened around the line for indicating by touch the direction of travel for safety or exits purposes. The braided metallic line has an outer protective layer. Preferably the braided metallic cable comprises a galvanized steel material and the outer protective coating is a transparent, translucent or clear plastic coating or sleeve that surrounds the outer perimeter of the braided cable. A transparent plastic material with a green color may be preferred when the escape line is used in the primary escape shaft. The material chosen for the braided metallic material should be such that its outward appearance is of a high metallic luster and/or a highly light reflective that exceeds the light reflective capability of the present polystyrene yellow rope now used in the mines. The tactile feedback information markers preferably are solid cones with a perforation through its base and apex for surrounding the cable and being attached thereto. The cones preferably have light reflective tape on their outer surface and light reflective tape is also positioned at spaced apart intervals along the length of said cable.

### BRIEF DESCRIPTION OF THE DRAWINGS

FIG. 1 is a perspective view of Mine Escape Line of the prior art.

FIG. 2 is a perspective view of the environment of Escape Line according to the present invention.

FIG. 3 is a perspective view of the Escape line according to the present invention.

FIG. 4 is a perspective view of the co-operating elements of connection on the escape line according to the present invention.

FIG. 5 is a side view of the escape line according to the present invention.

FIG. 6 is a sectional view 6-6 through FIG. 5 of the escape line according to the present invention.

FIG. 7 is a sectional view 7-7 through FIG. 5 of the escape line according to the present invention.

FIG. 8 is a sectional view 8-8 through FIG. 5 of the escape line according to the present invention.

FIG. 9 is a perspective view of an alternate configuration of the escape line according to the present invention.

FIG. 10 is a sectional view 10-10 through FIG. 9 of the escape line according to the present invention.

FIG. 11 is a sectional view 11-11 through FIG. 9 of the escape line according to the present invention.

### OBJECTS OF THE INVENTION

It is an object of the present invention to provide a more efficient and reliable mine escape safety line.

It is an object of the invention to provide a stronger mine escape safety line.

It is an object of the present invention to provide a more fire resistant mine escape safety line.

It is an object of the present invention to provide a more wear resistant mine escape safety line.

It is an object of the present invention to provide a light reflective material for a mine escape safety line.

It is an object of the present invention to provide a high luster visually detectable material for a mine safety escape line.

It is an object of the present invention to provide a

### DETAILED DESCRIPTION OF THE DRAWINGS

What is shown in FIG. 1 is a spool assembly 8 that contains a mine escape system shown at 10 coiled around the spool assembly 8. The mine escape system 10 comprises a polystyrene rope 12 having loops 14 on each end thereof so that the sections of the escape system 10 may be coupled one to the other by the quick coupler shown at 16. Spaced along the length of the polypropylene rope 12 are the cones 20 that are the direction cones for the mine escape system. When the mine escape system 10 is located along the length of a return air shaft with one end extending outwardly towards the exist of the mine, the cones 20 are spaced at various lengths along the line 12 preferably 75 feet along at any state can require the minimum number of cones that must be placed along the line 12. The cones shown at 20 are shown having an apex of the cone shown at 22 with the based of the cone shown at 24. Extending from the apex 22 of the cone 20 to the base 24 of the cone 20 are florescent stripes 26 that are placed around the circumference conical surface of the cone 20. When the florescent stripes 26 have portions 28 that extend across the base portion 24 of the cone 20. These portions 28 form an “x” on the base 24 of the cone 20 so when visible they indicate that traveling in that direction is the wrong direction for the miner to be traveling in the case of an emergency. The idea of the mine escape system line 10 is that the cones 20 will form a tactile means of information when a miner's hand is gliding along the rope 12. The rope 12 of the prior art is formed of a yellow high strength polypropylene rope or braided material that is usually yellow in color. The cones are placed and held upon the line by a central aperture that extends through the cone 20 and metal ferrules at 30 located in the front and back the cone 20 on the line 12. The prior art escape lines show the loops 14 formed with blank 36 holding the loops firmly in position.

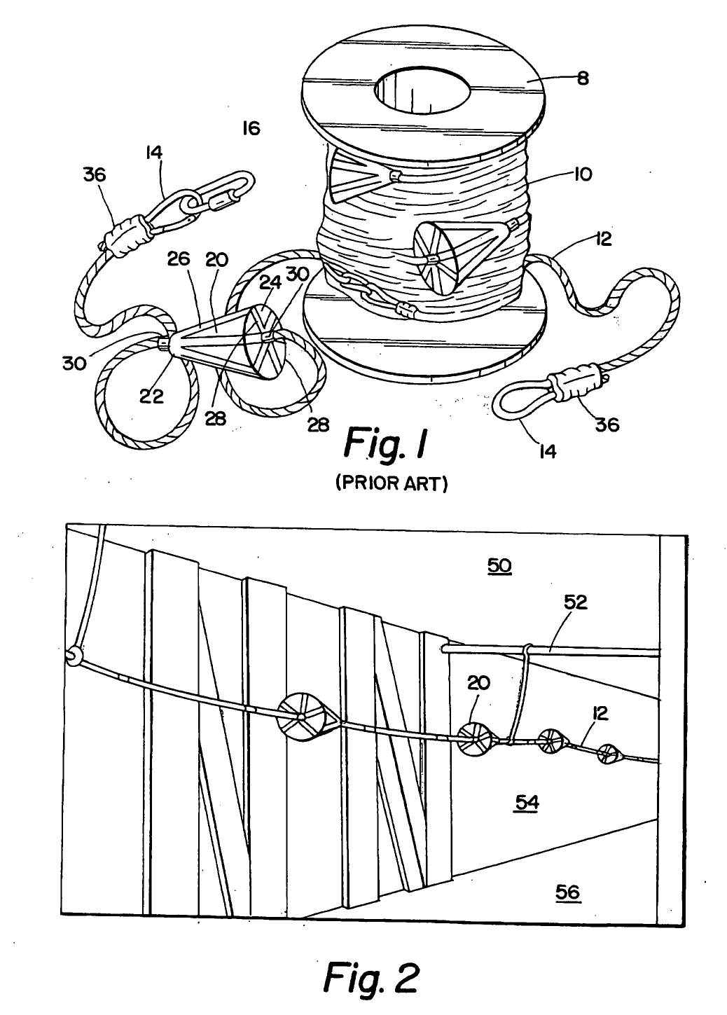

What is shown in FIG. 2 is the return airshaft 50 of a mine with the upper structures 52 located in a return airshaft 50. Sidewalls 54 and bottom walls 56 form the circumference of the return airshaft and suspended from the ceiling 52 is the mine escape line 12 with the cones 20 spaced along the length of the airshaft 50.

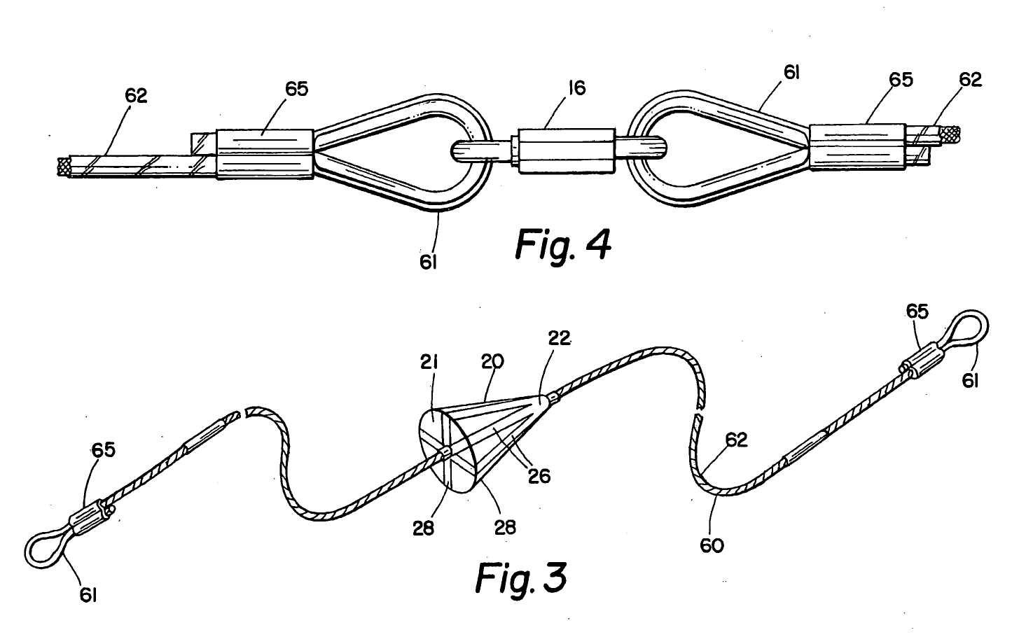

What is shown in FIG. 3 is the improved mine escape system 60 that has a braided or rope steel cable 62 with cones 20 fastened to the braided steel cable 62. The braided steel cable 62 is preferably of a steel material and is more preferably of an aircraft cable material. Such a material may be purchased form a company called Volunteer Rope And Supply Co., Inc. 1724 Mitchell Street, Knoxville Tenn. 37917. The preferable cable used with this invention is the 7×7⅛″ inside and 3/16 outside dimension, with the typical hooks 36 fastened at each of the cable material 62. Again the cones are shown having the florescent stripes 26 along the conical section of the cone 20 with the cone 20 having its apex 22 and its base at 24. The florescent stripes have sections 28 that when extending across the bottom 24 of the cone 20 form an “x”, when visible, indicating that it is the wrong direction for a miner to be traveling. The steel cable shown in FIG. 3 is a preferably a high strength flexible steel cable that has a shiny outward surface thereon.

What is shown in FIG. 4 are the ends 36 of the improved mine escape system 60 having the cable 62 doubled over and clamped as shown at 65 to form loops which the quick connect 16 may then join at an end to end relationship so as to form an continuous line from the deepest depths of a mine to the exit of the mine shaft.

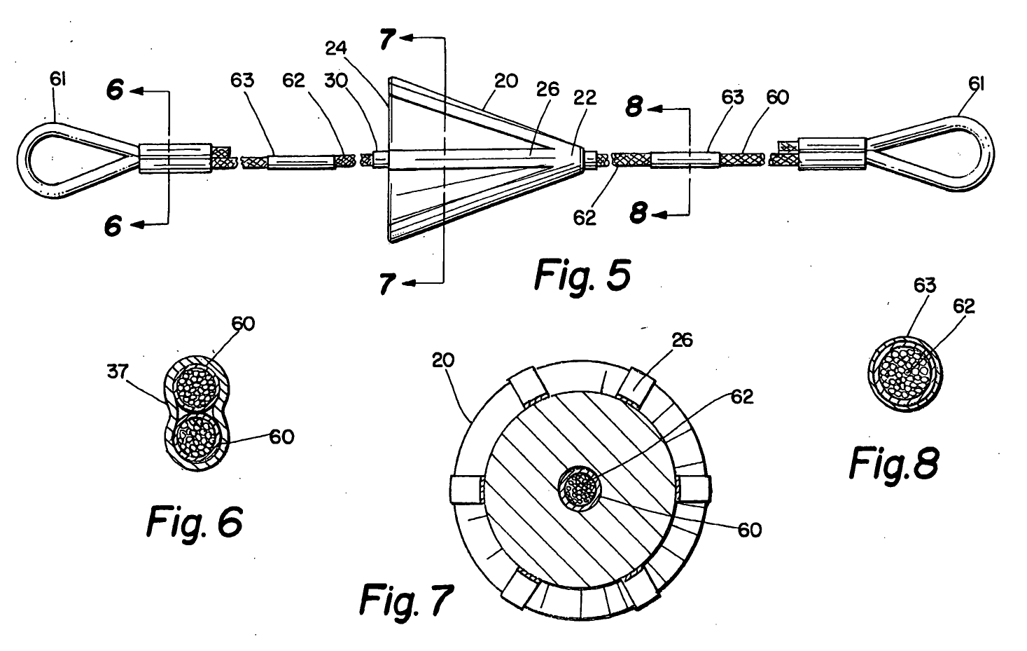

What is shown in FIG. 5 is the ends 36 of the improved mine escape system 60 shown with the braided steel cable 62 extending along the length of the mine escape system 60. The cone 20 is again shown located on the cable 62 with the florescent stripes 26 extending from the apex 22 of the cone to the base 24 of the cone 20. The ferrules 30 that are clamped on the steel line 60 bold the cone 20 firmly in place on the line 60 so that they do not move during operation. As stated earlier the cones 20 may be spaced along the length as required by either state law or federal law or as desired by the mine operators. The cable 60 has a insulting coating shown at 61 which is preferably of a plastic material and more preferably of a transparent plastic material. The plastic material is electrically insulating and also acts as a protective device so when a person runs their hand along the steel cable. Braided steel cables are known to have sharp edges that extend from the braiding the clear plastic insulating material protects the miner's hands from being injured when his hand is run along the cable. In addition the clear plastic material acts an electrical insulation against any wires or electrically products that may come in contact with the cable, and further acts as a corrosion resistant barrier to the steel or metallic braided or rope cable.

What is shown in FIG. 6 is a view 66 through FIG. 6. FIG. 6 shows the steel cable material 60 as it doubles over and is clamped by the clamp 37 that holds the cable and clamp in an assembled condition.

What is shown in FIG. 7 is a view 77 through FIG. 5 of the mine escape system 60. The cone 20 is shown having the fluorescent stripes 26 on its outer perimeter and having the braided steel cables 62 extend through the center of the cone 20. The cable 62 is shown having it a transparent plastic layer 63 on its outer perimeter and a transparent plastic layer 63 provides a protective layer on the cable 62. The protective layer 63 is protective in at least two ways. The plastic sleeve and/or coating protects a miner's hand from injury or damage due to any of the frayed metal braids that may be formed along the length of the braided cable. In additional the plastic transparent plastic material can act as a electrical insulating material should the braided steel cable come into contact with any electrical or any other stray wires.

What is shown in FIG. 8 is a further view of the cable 62 this time having an outer layer 61 that is preferably made of a transparent plastic. The outer surface of the galvanized metal cable 62 is chosen so that it has a high metallic luster and its outer surface may be polished or formed of a material so as the outer surface has a high reflective index or at least a light reflective index on the outer surface on the braided metal cable should be at least twice that of the prior art yellow polypropylene material that was previously used. This is used with the idea in mind that since a miner has a cap lamp on his helmet it may be used for a short duration in the event of an emergency and in the event that the vision is impeded at least besides the florescent stripes that are placed on the cones and along the length of the mine escape line there is an additional fact of the highly reflective nature of the new and improved galvanized aircraft cable according to the present invention.

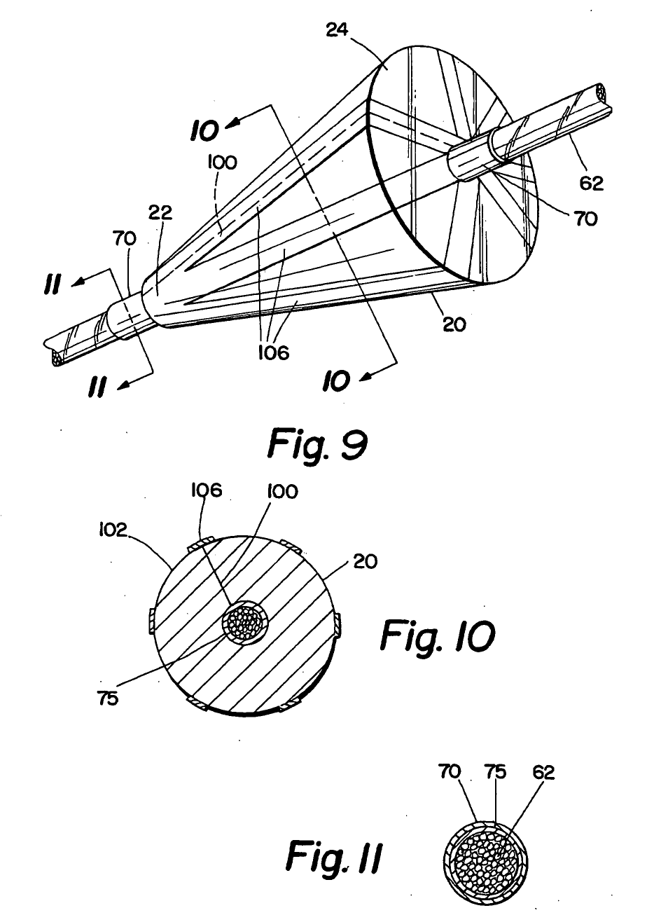

What is show in FIG. 9 is again a cone 20 on an aircraft cable 62 according to the present invention. The ferrules 70 are shown holding the cone 20 on the cable 62 with the cone 20 having a central aperture shown at 75 extending from the base 24 of the cone to the apex 22 of the cone. In a way that this is arranged it can be seen at the cone 20 complete surrounds the aircraft cable 62 and the cone 20 is held securely in place by the aluminum ferrules shown at 70.

What is show in FIG. 10 is a section 10-10 through FIG. 9 to achieve the desired goal having a customer purchase a standard mine escape system lifeline from the factory and adapt it to his own state requirements a cone 20 is shown having a slit 100 through its outer perimeter 102 to its inter perforation 75. With that slit one is able then to separate or open the length of the cone 20 and insert the cable down through the slit 100 until it rests in the internal perforation 75. Once the cable is in the internal perforation 75 along the entire length of the cone the cone may then be closed back up and a stripe of florescent adhesive tape 106 may then be placed along the length of the outer diameter of the cone 20 so as to hold it firmly in place. The pieces of tape are then placed in place of the aluminum ferrules shown at 70 and the line will then meet the state requirements.

What is shown in FIG. 11 is a view 11-11 through FIG. 9. FIG. 11 shows the inter braided galvanized aircraft cable 62 on the outer most perimeter of the aircraft cable is the clear plastic layer 75 and outer most from that is the aluminum ferrule 70 or a piece of tape 75 the can be used to hold the cone 20 on the braided cable 62. Slit aluminum stop sleeves may also be used in place of the tape.

1. A mine escape line which comprises:
a. a length of braided metallic cable having opposing ends;
b. cooperating elements of releasable connection means located on said opposing ends;
c. tactile feedback information markers attached around said cable at spaced intervals along said cable for indicating direction of exit or safety;
d. an outer protective layer on said braided cable.

2. The mine escape lien according to claim 1 in which said braided metallic cable comprises a galvanized steel material.

3. The mine escape line according to claim 2 in which said outer protective coating is a transparent plastic material.

4. The mine escape line according to claim 1 in which said metallic cable comprises a material having a metallic luster.

5. The mine escape line according to claim 4 in which said protective outer layer on said braided cable comprises a transparent plastic material.

6. The mine escape line according to claim 2 in which said tactile information marker comprises a solid cone having a base portion and an apex portion and having a perforation extending from and through said apex and base portions and means for attaching said cones to said cable.

7. The mine escape line according to claim 6 which further comprises light reflective tape positioned on the outer surface of said cones.

8. The mine escape line according to claim 7 which further comprises light reflective tape at spaced apart intervals along the length of said cable.

9. The mine escape line according to claim 5 in which fluorescent material particles are used in conjunction with said transparent plastic material.

10. The mine escape line according to claim 3 in which fluorescent material particles are used in conjunction with said transparent plastic material.
